(19) United States
(12) Patent Application Publication
(10) Pub. No.: US 2008/0244325 A1
(43) Pub. Date: Oct. 2, 2008

(54) AUTOMATED SOFTWARE SUPPORT SYSTEM WITH BACKWARDS PROGRAM EXECUTION AND DEBUGGING

(76) Inventor: Mikhail Tyulenev, New York, NY (US)

Correspondence Address: MIKE TYULENEV, 335 East 94 St., #B, NEW YORK, NY, 10128, US

(21) Appl. No.: 11/865,065

(22) Filed: Sep. 30, 2007

Related U.S. Application Data
(60) Provisional application No. 60/827,694, filed on Sep. 30, 2006.

(51) Int. Cl. G06F 9/44; G06F 11/36; G06F 15/16

(52) U.S. Cl. 714/38; 717/135; 709/204; 714/E11.212

(57) ABSTRACT

The invention describes an automated software support system comprising automated bug filing and test case creation component to checkpoint a client process initial state and record the client process initial state changes while the client process undergoes sequence of states which need to be analyzed, such as software bug, deliver the recordings to a development node, where the problem can be debugged without reproducing the client process environment by using the recorded state to recreate initial state of the client program and by using the recorded log to simulate the client program execution forwards and backwards.

### CROSS-REFERENCE TO RELATED APPLICATIONS

This application claims the benefit of provisional patent application Ser. No. 60/827,694, filed 2006 Sep. 30 by the present inventor.

### FEDERALLY SPONSORED RESEARCH

Not Applicable

### BACKGROUND OF THE INVENTION

1. Field of Invention

The present invention generally relates to software support and, more specifically, to software support automation using reconstruction of a state of interrupted computer programs, backwards and forwards execution, and debugging.

2. Prior Art

Any nontrivial software product enters support phase when it reaches customers. Software updates are deployed as bug fixes, patchsets, and minor and major software revisions (versions). The ability to timely and efficiently manage support issues that require software updates is critical for software product's long term success. Unhappy customers can decide to not renew software or support licenses and/or switch to competing products, all of which results in revenue loss for software vendors. Software vendors spend significant resources on keeping the existing customers happy. While bug tracking systems have been in place for many years, very little advance has been made in technology to handle the heart of the issue—figuring out the root cause of the application's problem. The challenge is that the symptoms of a software problem rarely reflect the root cause. Finding the glitch is not an easy task when it is not known where to start looking. The root cause of the problem could be a software error, a hardware fault, a configuration issue, or even an end-user's mistake. Pinpointing the root cause of a software problem can be especially difficult when the problem is happening at a remote customer site. Support teams typically go though a lengthy and costly process that includes endless conference calls, iterative attempts to gather information, costly trips to a customer site, and multiple attempts to recreate the customer's environment and the problem scenario. In some cases, in order to reproduce the customer's environment, a software vendor needs to duplicate confidential or classified information, so customer is typically forced to reproduce the problem using phony data, which further increases the cost of ownership of the application.

The invention eliminates the need to reproduce the problem and its environment by recording application's code execution flow on the customer's site and automates collaboration between customer and engineering and support teams and further reduces the time to determine the root cause of the problem by providing tools to replay captured code execution flow back in time.

Recording technique for debugging a computer program by simulating execution forwards and backwards have been proposed (U.S. Pat. No. 5,784,552); however, it applies to interactive debugging of a computer program currently being executed while present invention uses backwards and forwards debugging of a program executed in the past at a different computer node. Present invention, unlike prior art, specifies a method and apparatus to use a conventional debugger to record data needed to simulate program execution in a future. The benefit of this method is that software developers and support engineers do not need to use different tool to debug a computer program and that makes this method easily adoptable by majority of software developers. Present invention uses recording of changes in a process state in combination with other techniques in a context of automating software support by reproducing software fault remotely, while prior art focuses on interactive debugging.

The invention significantly reduces the time and effort spent in the bugfixing cycle, reducing software vendors' internal costs. It also increases customer satisfaction by reducing bug fix turnaround time, and frees up software vendor's development resources for less mundane and more creative work, such as product enhancements, new features and products.

### SUMMARY OF THE INVENTION

The invention describes an automated software support system comprising automated bug filing and test case creation component to checkpoint a client process initial state and record the client process initial state changes while the client process undergoes sequence of states which need to be analyzed, such as software bug, deliver the recordings to a development node, where the problem can be debugged without reproducing the client process environment by using the recorded state to recreate initial state of the client program and by using the recorded log to simulate the client program execution forwards and backwards.

### BRIEF DESCRIPTION OF THE DRAWINGS

FIG. 1: Record process state and memory changes

FIG. 2: Stepping backward in Back in Time Debugger

FIG. 3: Passing Control between Common Debugger Process (CDP) and Back in Time Debugger Process (BDP)

FIG. 4: Methods to record instruction data

FIG. 5: Bug Resolution Process

FIG. 6: Automated Support System

FIG. 7: Automatic Testcase Creator

### DETAILED DESCRIPTION OF THE PREFERRED EMBODIMENT

### Concepts

### Systems Architecture and Bug Resolution Methods

The system comprises a
1 Back in time (sometimes referred as backward or reverse) debugger
2 Internet-based online bug tracking and collaboration software
3 Automated bug filing and test case creation component.

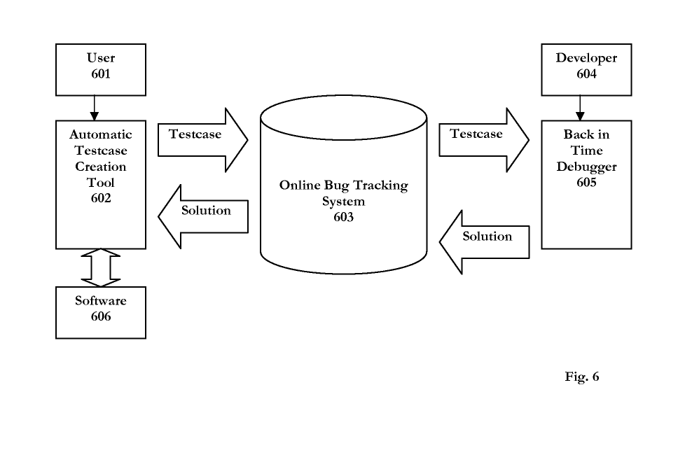

The bug resolution process using the automated support system is depicted on FIG. 6. Assume that the User, 601 experiences a fault of the Software, 606. To obtain the solution or software patch the User, 601 invokes the Automatic Testcase Creation Tool, 602 to create a testcase. After that the testcase is automatically transmitted to the Online Bug Tracking System, 603 where it matched against stored solutions in order to find out if it's the new issue. If the testcase represents the new issue it is transferred to the development center where Software Developer, 604 uses Back in Time Debugger, 605 to reproduce and fix the problem. After fix is found it transmitted to the Online Bag Tracking System and automatically delivered to the User, 601.

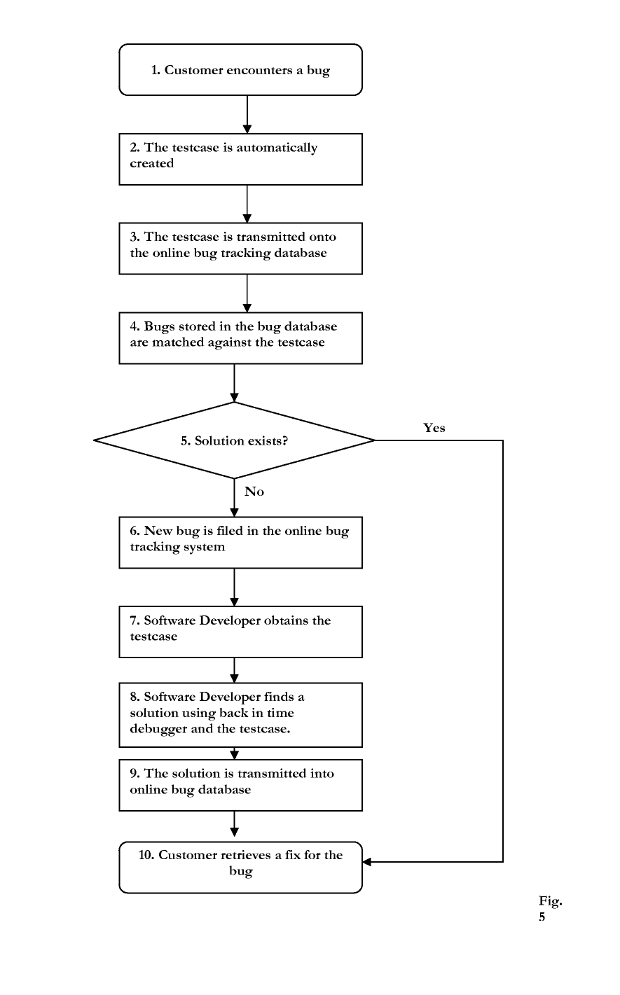

This process in details is depicted on the FIG. 5.

### Automatic Testcase Creator

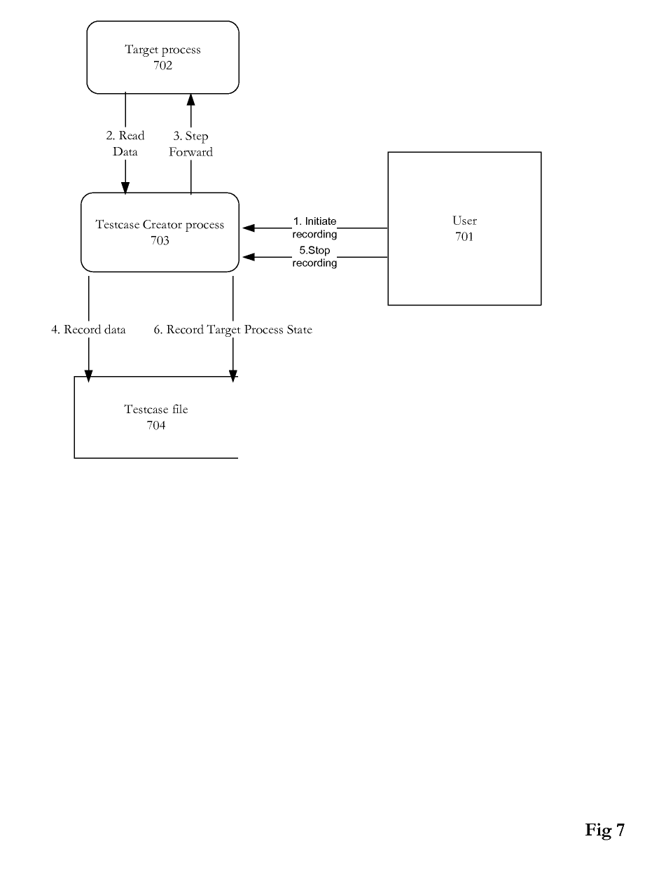

The Automatic testcase creator attaches to the process or group of processes representing the system where faulty behavior occurs and records execution flow into the log file. The process of recording is depicted on the FIG. 7

User (701)—a human or a software program
Target Process, being debugged—TP (702). The TP is a running software program which needs a testcase

### Testcase Creator Process—TCP (703).

The Testcase File—TF (704), is a specific for a Testcase Creator and Backward Debugger data stored on a hard drive or other media.
(1) The user, 701 initiates recording, using Testcase Creator interface. The recording process consists of several steps. The user also has to manually stop the recording or specify the “stop recording” condition.
(2) TCP, 703 fetches the instruction which is about to be executed, parses it, and reads the memory content and processor registers which will be updated.
(3) The process state data is saved in the Testcase File, 704.
(4) The TCP, 703 check's the “stop recording” condition. If it's not met TCP, 703 commands the TP, 702 to step one processor instruction forward.
The steps (2), (3), and (4) repeated until “stop recording” condition is met or until User, 701 manually stops the recording. When “Stop Recording” condition is met the recording stops and control on the TP, 702 is passed back TCP, 703.
(5) The User, 701 issues a command to stop recording
(6) The TCP, 703 saves the process state also sometimes referred as process checkpointing (memory mapping and content, stack, registers) and environment (shared libraries, environment variables) into TF, 704.
Now the TF contains all the information needed to match the bug against the online database and resolve it using Backward Debugger.

### Match the Bug Against the Online Database

In the present embodiment a popular bug tracing software known as Bugzilla is used to facilitate common bugtracking features; such as search of a bug by number or sequence of characters in its description, recording comments and associating files with a particular bug. The Testcase creator uses Bugzilla API to create a bug, compose its description, OS, hardware and associate a Testcase file with said bug. When a new bug is being filed by a testcase it uses the following algorithm to match new testcase file against stored testcase files to identify if the bug being filed has already occurred or not.

The matching program compares history logs created by testcase creator starting from the latest records and moving back in time to determine if the software was terminated with a signal caused by memory access violation then check if the violation was caused by a same procedure and by attempt to address same address in memory in both cases and if so check back trace and if function calls and their arguments match in both cases then consider two bugs identical, otherwise consider them different.

### Backward Debugger

### Computer Architecture

Typical computer consists of CPU, memory, storage (such as hard drive) and peripherals (keyboard, video adapter). CPU is a central part of the computer it executes the program instructions.

### Program Execution

From the program execution point perspective CPU execution environment defines and controls the program execution. After loading the program the CPU on every step executes the instruction address of which is in the instruction pointer register (EIP on Intel IA-32 CPU). After executing the current instruction the CPU loads the address of the next instruction in the instruction pointer register.

### Program Debugging

The debugger uses the software or hardware (implemented in CPU) traps to halt execution of the current program and pass control to another routine—a debugger.

### Debugging Session

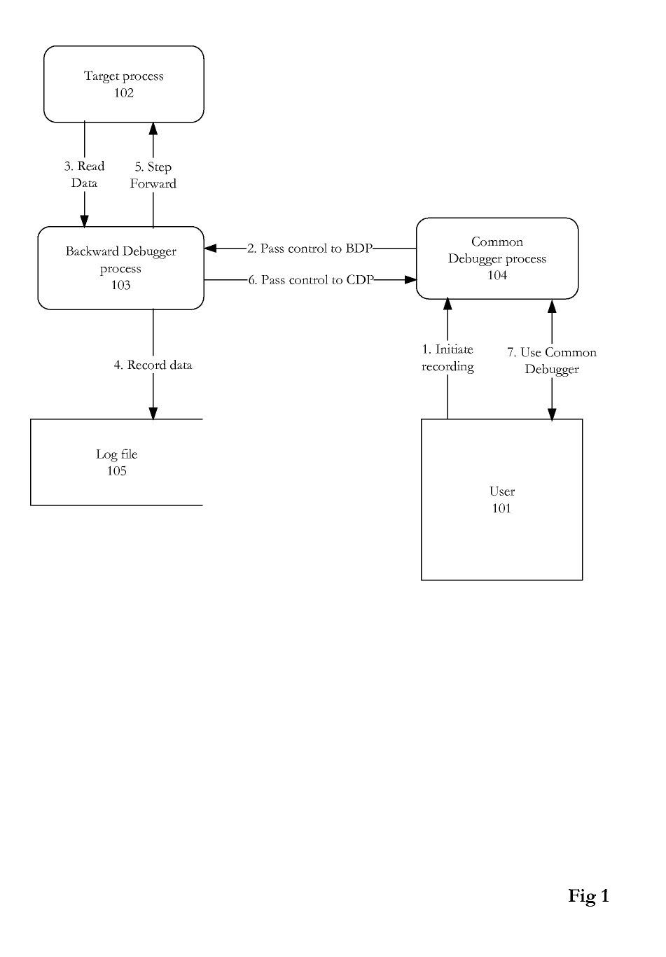

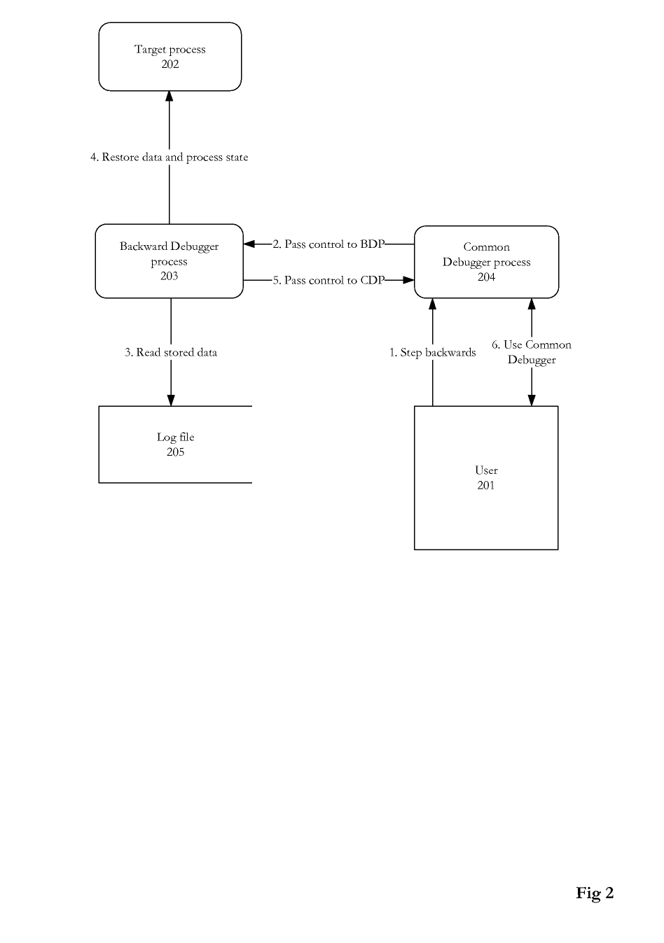

The debugging session consists of two parts:
1. recording data, representing process state in the log file while executing program (Illustrated on FIG. 1)
2. stepping backwards using recorded data (Illustrated on FIG. 2)
The term “process state data” means main memory address and memory value at this address or CPU register's address and the value at the address.

### Recording Data, Representing Process State

The FIG. 1 is a block diagram of the recording data representing current state of a process.

User (101)—a human or a software program
Target Process, being debugged—TP (102). The TP is a running software program being debugged
Backward Debugger Process—BDP (103). The BDP is a running Backward Debugger
Common Debugger Process—CDP (104). The CDP is a running Common Debugger
The Log File—LF (105), is a specific for a Backward Debugger data stored on a hard drive or other media.
(7) The user, 101 uses methods provided by CDP, 104 to start a TP, 102 or, if TP is already running, attach to a TP. User performs all debugging activity using facilities provided by Common Debugger
(1) The user, 101 initiates recording, using Common Debugger interface. User also has to provide the “stop recording” condition, such as function address, or variable value to stop recording before program stops execution. The recording process consists of several steps.
(2) CDP, 104 passes control over TP, 102 to the BDP, 103.
(3) BDP, 103 fetches the instruction which is about to be executed is parses it, and reads the memory contents and processor registers which will be updated.
(4) The process state data is saved in a log file, 105.
(5) The BDP, 103 check's the “stop recording” condition. If it's not met BDP, 103 commands the TP, 102 to step one processor instruction forward.
The steps (3), (4), and (5) repeated until “stop recording” condition is met.
(6) When “Stop Recording” condition is met the recording stops and control on the TP, 102 is passed back from BDP, 103 to CDP, 104.
(7) Now the User, 101 can not only step forward but also step backwards using CDP, 104 interface.

### Stepping Backwards Using Recorded Data

The FIG. 2 is a block diagram of a stepping backwards process.

User (201)—a human or a software program
Target Process, being debugged—TP (202). The TP is a running software program being debugged
Backward Debugger Process—BDP (203). The BDP is a running Backward Debugger
Common Debugger Process—CDP (204). The CDP is a running Common Debugger
The Log File—LF (205), is a specific for a Backward Debugger data stored on a hard drive or other media. The Log File is either a log file generated during the debugging session, illustrated on FIG. 1, or a Testcase File generated by a Testcase Creator in the process illustrated on the FIG. 7.
(1) The User, 201 issues command to step backwards using Common Debugger interface
(2) The CDP, 204 passes control over TP, 202 to the BDP, 203
(3) The BDP, 203 reads process state data from the log file, 205.
(4) The BDP, 203 writes process state data received in the previous step into the space of TP, 202
The steps (3) and (4) are repeated until either breakpoint is reached, condition met, or specific number of instructions has been rolled back. The number of instructions depends on whether it's a line of code or explicit number.
(5) The BDP, 203 passes control back to CDP, 204
(6) User, 201 can examine memory and registers using methods facilitated by the CDP, 204.

### Methods to Transfer Control Between BDP and CDP

In the preferred embodiment the backward debugger and the common debugger are separate programs running as separate processes. This way the features implemented in a common debugger and specialized features in a backward debugger may be used together. Alternatively the common debugger features could be implemented in a backwards debugger, eliminating the need of control transferring techniques described below.

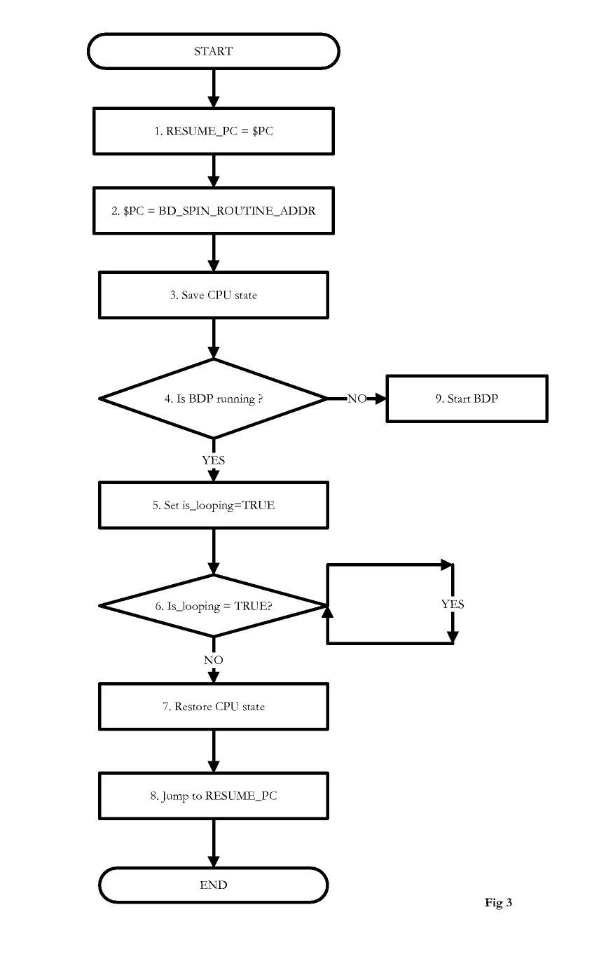

Initially, when user starts the Common Debugger and the Target Process there is no BDP. It must be started and initialized. While the BD starting the TP state must remain unchanged to allow debugging with the BD.
The FIG. 3 outlines procedure executed in the TP. To do so the CDP sets instruction pointer of the TP to point to correspondent “spin” routine of the BD.
1) Store the current value of the Instruction Pointer (PC on IA-32)
2) Go into BD_SPIN_ROUTINE. The following boxes describe this routine
3) Save CPU state into memory. CPU state depends on the CPU architecture. On Intel CPU it includes CPU register values, stack, and CPU, a math coprocessor (FPU) and multimedia extensions state (MME).
4) If BDP has been started do nothing. Otherwise start it
5), 6) Enter into the infinite loop. This is done to prevent the TP from changing its state. The loop can be exited only when the is_looping value is changed to FALSE. This will be done by BDP when it's ready for debugging.
7) Restoring the CPU state
8) Return to a point where normal execution of TP was interrupted
9) Create (fork) Backwards Debugger Process. After BDP is started it will execute the initialization routine.
Returning of the control from the BDP to CDP is implemented as setting the value of is_looping variable to FALSE, therefore letting the TP to get out of the spinning “state”.

### Recording Memory Changes in the Log File

The FIG. 1 provides the architectural overview of recording process. The section below provides the details on the implementation.

### Methods to Record Instruction Data

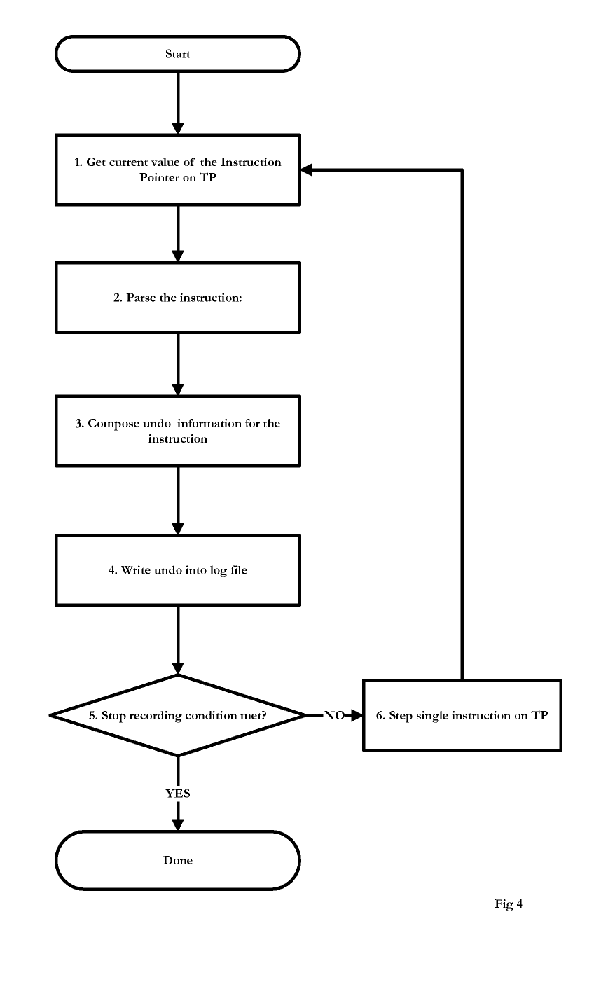

The BD instruction parser represents instructions on the FIG. 4

The BD goes into “Start” state for recording undo data when the User commands the recording to begin. The start_recording command also may include “stop condition” such as an expression or function address.
1) Retrieve the current instruction pointer from the Target Process. On *nix it may be done using ptrace system call.
2) Parse the instruction.
The program is stored in the executable file in a format specific for the operating system. The most common are COFF and ELF binary formats. In both formats the program is represented as a sequence of operation codes and their operands. In the BD the two-stage parsing is used. The first stage—the conversion of the binary code into text representation is done by the software distributed with the binutils linux package. The second stage—the conversion from text to the in-memory structure is implemented as a set of a parsing rules for Lex and Yacc—software libraries to generate parsers based on a parsing rules text representation. To add new instructions a line describing the instruction must be added into the file defining the parsing rules. This is simpler then parsing instructions in a dedicated parser and therefore allows more efficient, versatile and reliable implementation. Additionally the parsing engine based on Lex and Yacc could be quickly extended to support different platforms and instruction sets. The preferred embodiment is implemented on Unix platform, where common format for representing assembly instructions is an AT&T format. The Intel assembly format is the format used on Windows platforms. The AT&T and Intel formats are equivalent. An assembler instruction in AT&T syntax has the form:
OpCode [operand1] [operand_N]
The first argument is a “source” and the following argument is a “destination”.
OpCode is the operation code, operands are optional.
Operand could be an explicit value, a reference to memory, or register. The OpCode defines the size of the operands. It can be 8 bit, 16 bit, 32 bit, 64 bit.
Instruction affects CPU state, registers, memory, and stack. One instruction could change several items, for example IA-32 instruction PUSH updates stack and stack pointer.

### 3) Compose Undo Information

Based on the parsed instruction the BD identifies what process state data will be changed when this instruction is executed and compose a data structure with values before executing current instruction. FIG. 5 is a data structures for storing undo data. To read the current values of registers, or memory it uses ptrace.
4) Write undo into log file. FIG. 6 represents the data record. To provide space efficiency the file is compressed.
5) Check if condition “stop recording” is TRUE. The acceptable conditions: Address, or expression, or breakpoint
6) Execute the current instruction and repeat the steps 1 thru 5
When Done the control is transferred from the BDP to CDP

### Methods to Record OS Specific Calls (System Calls)

Another part of changes happens during the “system calls”. The system call is an OS routine which is part of the OS kernel. It's executed in the separate address space when a control is passed to the OS kernel from a user program. System calls perform I/O operations, process control, privileges management etc. In Linux and Windows control is passed to the OS by either issuing an interrupt or by using special instruction. In general the input values for a system call have predefined addresses on the stack or registers as well as an output. The reverse debugger is capable of finding out what kind of system call will be executed, parsing its input parameters and recording the memory that could change as a result of the system call.

### Methods for Stepping Backward

“Stepping backwards” or reverse execution becomes available after the log file which contains the values of the memory and registers. The “log file” is either a log file generated during the debugging session, illustrated on FIG. 1, or a Testcase File generated by a Testcase Creator in the process illustrated on the FIG. 7.

The log file consists of
<record size> <record data> pairs, where <record data> has the form <record type> <type-specific data>. Upon reading and parsing data the Reverse debugger connects to a Target Process and updates the memory with the values stored in a log file. Therefore the updating also changes the instructor pointer, so effectively the process is restored to the state point where it was during the forward execution.

I claim:

1. A computer-implemented method of a deferred analysis of a client program executing at a client node which is located remotely from a developer node, comprising:
(a) capturing an initial state of said client program,
(b) recording a log of changes in said state of said client program while said client program is executing on said client node,
(c) using the captured initial state of said client program to reproduce said initial state on said developer node,
(d) using said log to simulate the captured execution flaw of said client program on said developer node,
whereby the captured execution flaw of said client program can be simulated and analyzed on said development node without reproducing an environment of said client node.

2. The method of claim 1, wherein said deferred analysis is used to investigate and resolve a defect of said client program.

3. The method of claim 2, wherein the defect analysis comprises:
(a) storing said initial state and said log to a defect database into a client defect record,
(b) finding a similar defect record by matching said initial state and said log against other captured initial states and other logs stored in said defect database,
(c) if said similar defect record is found providing a computer user operating said client node with information associated with said similar defect record,
(d) if said similar defect is not found provide a software developer operating said developer node with information associated with said client defect record,
(e) using the captured initial state of said client program to reproduce said initial state on said developer node,
(f) finding an error in said client program by debugging said client program on said developer node by simulating execution forwards and backwards using said log
(g) finding a solution for said error,
(h) updating said client defect record in said defect database with said solution information,
(i) providing said client user with said solution.

4. The method of claim 1, wherein a human user controls capturing of said initial state and creating of said log while said client program is executing

5. The method of claim 1, wherein a computer program controls capturing of said initial state and creating of said log while said client program is executing

6. The method of claim 1, wherein said deferred analysis is used to demonstrate execution flaw of said client program for training purposes

7. An apparatus for a deferred analysis on a developer node of a client program executing on a client node, comprising:
(a) means to capture an initial state of said client program
(b) means to record a log of changes in said initial state of said client program while said client program is executing on said client node,
(c) means to restart said client program in said initial state on said developer node,
(d) means to simulate execution of the restarted client program forwards and backwards on said developer node using said log.

8. The apparatus of claim 7, further comprising: database for storing, searching and retrieving said initial state and said log

9. The apparatus of claim 8, further comprising: means to find a stored log similar to the client program log of changes

10. The apparatus of claim 8, further comprising: means to exchange information between a client executing said program and a developer using the stored log to analyze the recorded execution flaw of said client program
